(19) United States
(12) Patent Application Publication
(10) Pub. No.: US 2015/0370465 A1
(43) Pub. Date: Dec. 24, 2015

(54) Software Interface and Method for Ranking or Rating Items

(71) Applicant: SWG Enterprises LLC, Short Hills, NJ (US)

(72) Inventor: Steven W. Green, Short Hills, NJ (US)

(21) Appl. No.: 14/714,971

(22) Filed: May 18, 2015

Related U.S. Application Data
(60) Provisional application No. 61/994,916, filed on May 18, 2014.

(51) Int. Cl. G06F 3/0484; G06F 3/0488; G06F 3/0482; G06F 17/30

(52) U.S. Cl. CPC G06F 3/04847; G06F 17/30876; G06F 3/04842; G06F 3/0488; G06F 3/0482

(57) ABSTRACT

A software user interface for rating items using a set of rating criteria is provided, and a method for using that user interface for rating items. Criteria for the rating are assigned weights, and items are assigned a score within each criteria. An overall rating score is calculated for each item based on its scores under each rating criteria and the weights assigned to the rating criteria.

### CROSS-REFERENCE TO RELATED APPLICATIONS

This application claims benefit to U.S. Provisional Patent App. No. 61/994,916, filed May 18, 2014, the disclosure of which is hereby incorporated by reference in its entirety.

### BACKGROUND OF THE INVENTION

In a wide variety of situations, one may desire to compare items to one another, or create a list of items in some meaningful order. For example, such comparisons or lists can aid a person when they are making a decision, or trying to determine the most suitable item for a particular purpose, or simply inquiring about which item is “the best”.

A known, common method for performing comparisons is to begin by identifying a set of criteria pertinent to one or more items. Items are then rated or scored in each criterion. Scores for each criterion may be added together to obtain an overall score for the item in all criteria. A higher overall score then represents a more favorable rating or a higher ranking in the list.

Further enhancement of this method is necessary when the different criteria should not be weighted equally. In such cases, a known method is to assign a value to each criterion that represents its importance level as compared to the other criteria. The overall score for each item in the comparison is then determined by calculating the sum of scores weighted by the importance level of each criterion.

Spreadsheet and database software, known in the prior art, can be useful in effecting the method described above. See the example in FIG. 6. The spreadsheet or table interface, however, presents a number of disadvantages. These disadvantages are especially notable in the area of mobile software applications. The screen size of smaller devices such as mobile devices and tablet computers is often too small for the user to easily view a table of numbers. On touchscreen devices, manual number entry and adjustment in a table is more cumbersome than typical touchscreen applications. While multipurpose interfaces such as spreadsheets are common on traditional personal computers, more narrowly-purposed software applications and interfaces are preferred on mobile and tablet devices.

### BRIEF SUMMARY OF THE INVENTION

The present invention is a software user interface for rating or ranking items using a set of criteria. It is novel in the way that it presents the information to the user and allows the user to easily interact with it.

Criteria for the rating or ranking are set using a “Template” which allows the user to easily add criteria and adjust the weight of each one using the touchscreen interface. A Template is then linked to a list of items being ranked or rated, thus associating those items with the criteria in the interface.

The interface allows the user to display a list of items with their corresponding scores not only overall, but for each criterion as well, in the “Category View”. It also allows the user to display a single item's score in every criterion, in the “Item View”. Scores may be editable from each type of screen, using a touchscreen interface element such as a slider or keypad.

One embodiment of the invention also includes the ability for the user to take detail notes for each item in each category, as well as add images for each item and for each item in each category. Images and detail may also be added for the criteria in the Template.

An overall score for an item is calculated based on that item's score in the criteria and the weight assigned to those criteria. These overall scores are displayed to the user in the interface, allowing a display of overall rankings in addition to rankings in each category. Furthermore, the invention includes the application of mathematical formulae described herein to calculate overall item rankings based on these inputs, when used in a software interface for ranking or rating items.

### BRIEF DESCRIPTION OF THE DRAWINGS

FIG. 1 shows a ranking Template screen of an embodiment of the invention, with a display of multiple criteria. Each criterion 101 has a weight of 0-99 assigned to it, which is displayed by the position of a slider control 102 as well as the number to the right of the slider control 103. An info button 104 opens a detail display for each criterion (see FIG. 2).

FIG. 2 shows a detail view of one criterion in the Template screen of an embodiment of the invention, which includes display of detail text 105 and an image 106. To demonstrate additional features of this embodiment, this screen is shown in a “locked” state 107 that prevents editing and provides access to different feature buttons 108 at the bottom of the screen.

FIG. 3 shows an Overall Ranking screen of an embodiment of the invention, with a display of multiple items. This Ranking is associated with the Template of FIGS. 1-2, and the position of the sliders 109 for each item 110 and scores 111 to the right are not adjustable, but calculated based on each item's score in each criteria, and the weight assigned to the criteria. An image 112 and detail text 113 is displayed for each item, and the user may scroll down through multiple items. An arrow 114 to the right of each item allows the user to navigate directly to the Item View for that item (see FIG. 5).

FIG. 4 shows an embodiment of the invention with a Category View for the Ranking of FIG. 3. The user may use the slider control 115 or direct input into the score 116 to the right to adjust each item's score for the criterion 117 displayed at the top. The weight 118 currently assigned to the criterion is shown in parentheses next to the name of the criterion. A Category View is available for each criterion in the Template associated with this Ranking, and right and left arrows 119 on either side of the criterion name allow the user to navigate between the Category Views. The image 120 and detail text 121 for each item 122 is different for each Category View, providing information for that item specific to that criterion. An arrow 123 to the right of each item allows the user to navigate directly to the Item View for that item (see FIG. 5).

FIG. 5 shows an embodiment of the invention with an Item View for the Ranking of FIGS. 3-4. The item name 124 is displayed at the top, along with an image 125 and detail text 126. This screen displays the item's scores in each of the criteria 127 of the associated Template. An Item View is available for each item in the Ranking, and right and left arrows 128 on either side of the item name allow the user to navigate between the Item Views. The weight 129 assigned to each criterion is shown in parentheses for each. Scores for each criterion may be set using the slider control 130 or direct numerical entry 131. The user may scroll down through the multiple criteria. Images 132 and detail text 133 with information on the item relevant to each criterion is displayed. An arrow 134 to the right of each criterion allows the user to navigate directly to the Category View for that criterion (see FIG. 4).

FIG. 6 shows a spreadsheet table containing the information presented in the embodiment of the invention depicted in FIGS. 1-5.

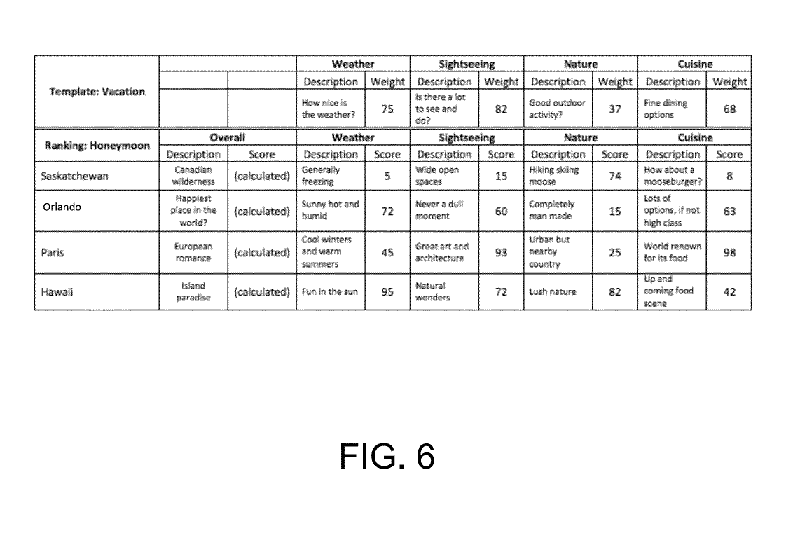

### DETAILED DESCRIPTION OF THE INVENTION

A “Ranking” as used in this specification consists of two or more items that are scored in one or more criteria. In embodiments of the invention, criteria are organized into lists of categories referred to as “Templates”, which include a weight assigned to each criterion. The terms “criterion” and “category” are used interchangeably in this application, as are the plural “criteria” and “categories”.

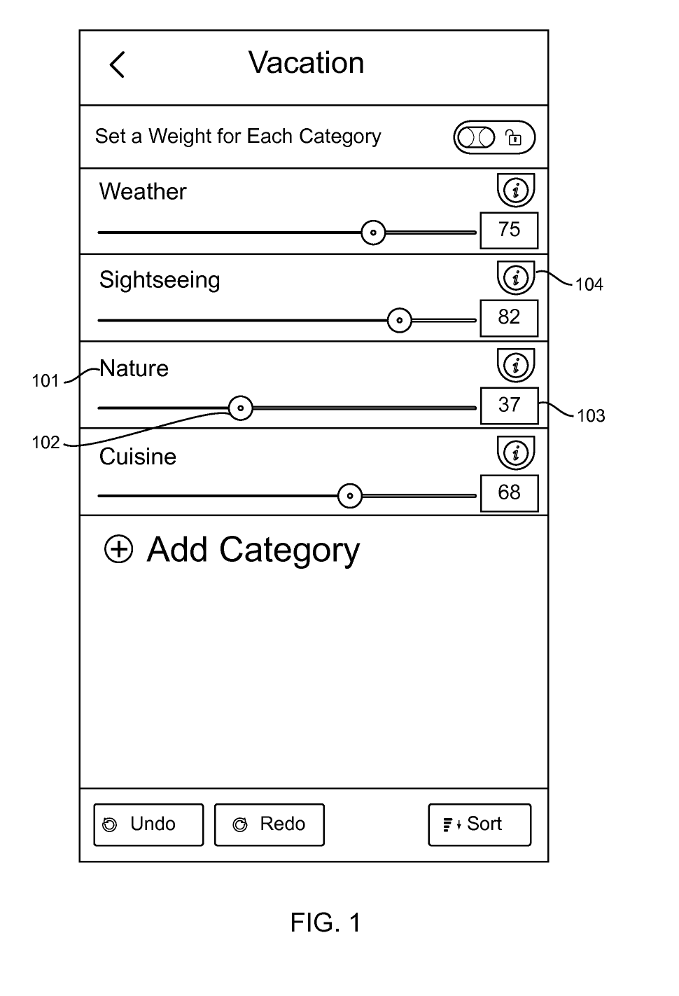

The Template interface (see FIG. 1) of embodiments of the invention provides the ability to clearly see the name of each criterion and its weight, and the ability to easily adjust weights using a graphical user interface.

In the embodiment shown in FIG. 1, the example Template provides criteria for ranking travel destinations. Criteria including weather, sightseeing, and cuisine have been placed in the Template, and a button at the bottom of the list allows the user to add additional criteria. This embodiment of the invention, built for a touchscreen interface on a mobile device, allows the user to adjust the weight of each criterion in the Template using a slider control 102. The weight 103 is displayed numerically to the right of each slider. In this embodiment the user may also press and hold the weight number to display a number keypad, allowing manual direct input of a precise weight number value. This numerical input adjusts the slider, and user adjustments to the slider control similarly update the weight number instantly, so the weight number displayed and corresponding slider control are always synchronized.

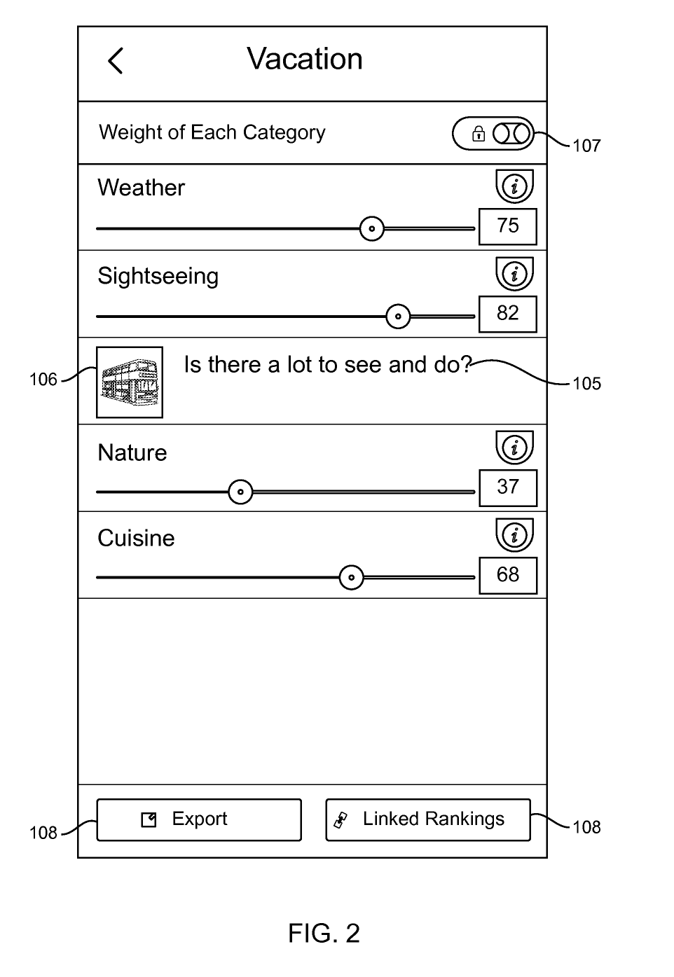

An additional feature of the Template in the embodiment shown in FIG. 1 allows the user to “lock” all weight adjustments and other editing of the Template. This feature is useful in preventing accidental changes to a Template's criteria or weights. In the “locked” position, the Template may not be edited, and the lock icon switch 107 clearly indicates its current state. (see FIG. 2)

At the bottom of the locked Template shown in FIG. 2, additional features of this embodiment of the invention are shown. The “Export” button 108 on the lower-left allows the Template in the software application to be exported into a number of formats, including text, spreadsheet, and image formats, by a number of communication methods such as email, instant message, or uploading to local, network, or internet storage. Exported Templates may also be stored in or synchronized with online databases, or shared on Internet websites or social media platforms. The “Linked Rankings” button 108 on the lower-right displays a menu of all Rankings associated with the present Template, allowing the user to navigate directly to the Overall Ranking screen for each.

Additional details about the criteria in the Template of this embodiment may be displayed and available for editing as well, including a text description 105 and/or image 106 for each category. In the embodiment shown in FIG. 2, this detail information is selectively displayed when the user presses an information button next to each category name.

Use of the export and linked rankings features and viewing of criteria details do not require the Template to be in a locked state. FIG. 2 is shown with these features and FIG. 1 without simply for visual convenience here.

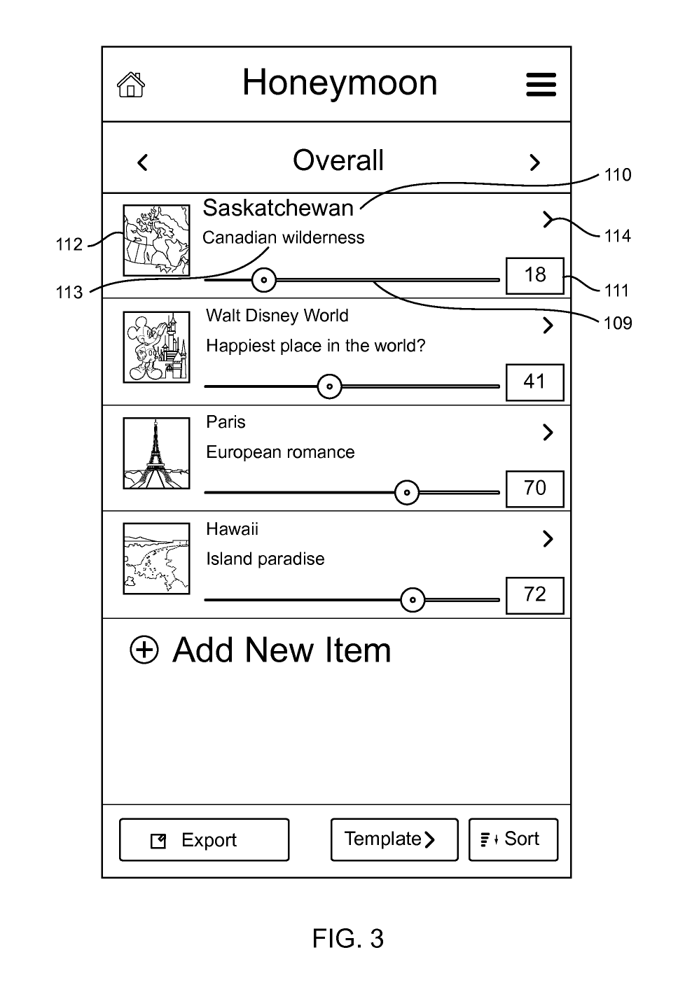

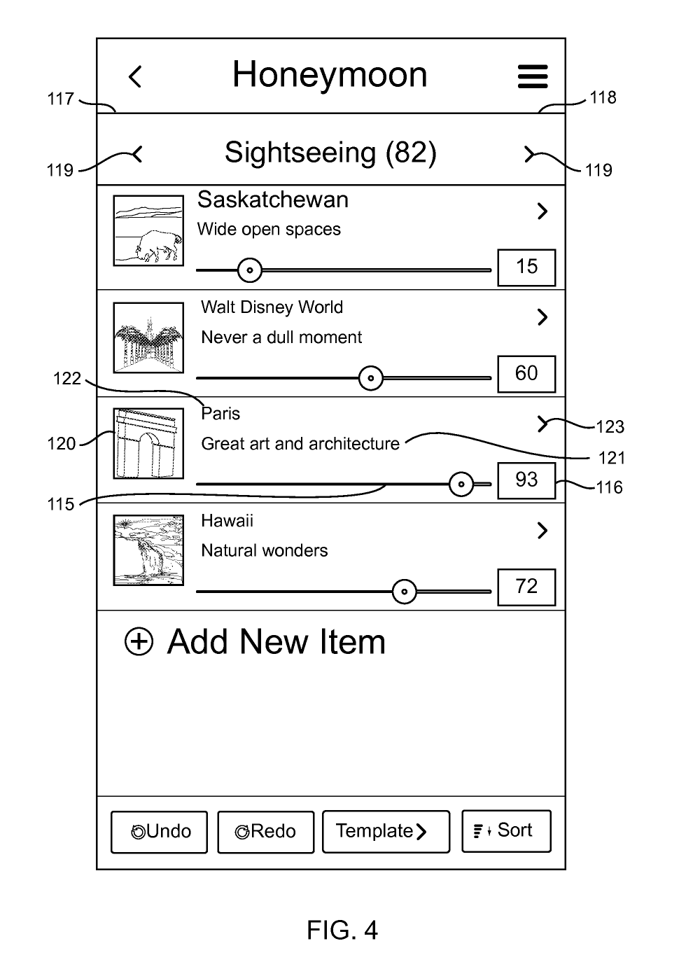

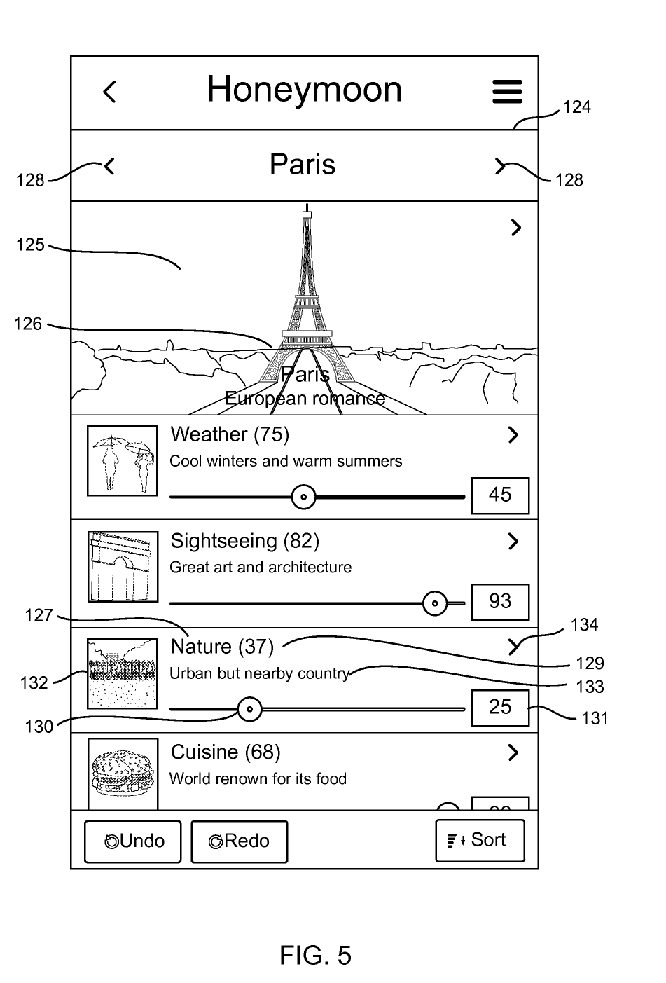

The Ranking interface of the embodiment in the drawings is comprised of three types of screens: the Overall Ranking screen (see FIG. 3), the Category View (see FIG. 4), and the Item View (see FIG. 5). Each of these screens are similar in that they contain a header followed by a list of cells with sliders and their accompanying scores. In the Overall Ranking and Category View screens, each cell represents an item which is being ranked. In the Item View, each cell represents a category in which a single item is being ranked. All three views may allow entry and display of detail information including a text description and/or image in each cell.

The Overall Ranking screen (FIG. 3) in the embodiment shown by the drawings provides a calculated overall score for each ranked item, which is derived by a calculation whose inputs are the item's score in each category and the weights assigned to each category.

In the embodiment shown in FIG. 3, the overall score 111 is on a scale from 1 to 99, as is as each category weight 103 and item score (116, 131) in each category. This embodiment applies the following method to calculate an overall score for each item:

$$n = number of categories$$

$${W}_{c} = weight assigned to category$$

$${IR}_{c} = Category Importance Ratio = \frac{{W}_{c}}{\sum {W}_{c }}$$

$${S}_{c} = Item Score for Category$$

$$Overal Score for Item = {\sum }_{c = 1}^{n} ( {IR}_{c} \times {S}_{c} )$$

The above formula may be used if the range for item scores in each category is equal to the range used for overall scores, as in the embodiment of FIG. 3 in which both are on a scale from 1 to 99.

By adjusting this formula to add a scaling coefficient as follows, a different range may be used for the overall score:

$${C}_{s} = Scaling Coefficient$$

$$Scaled Overall Score for Item = {C}_{s} {\sum }_{c = 1}^{n} ( {IR}_{c} \times {S}_{c} )$$

For example, an embodiment of the invention may use a range from 1 to 5 to score items in individual categories, and a range from 1 to 100 for overall scores. In this case, a scaling coefficient of 20 would be used.

Other embodiments of the present invention may use other methods for calculating an overall score for an item. Any method in which the inputs include the item's score in each category and the weight assigned to each category may be used.

The embodiment of FIG. 3 does not allow the user to edit the overall score directly, because it is calculated as described above. It may be useful to allow direct editing or adjustment of overall scores, but this is not shown in the embodiment of the drawings.

In the embodiment of FIG. 3, right and left arrows on each side of the dark bar at the top allow navigation from this Overall Ranking screen to Category Views for the Ranking. The title of the Ranking is displayed at the top center. Touching the three-bar icon in the upper-right displays the list of categories used for the Ranking, allowing the user to directly navigate to any Category View by touching its category name. Touching an arrow 114 to the right of each item navigates directly to the Item View for that item. The description 113 and image 112 for each item displayed here is the main description and image for that item. Touching and holding on the item names or descriptions allows direct editing of the text displayed. A button at the bottom of the list of items allows the user to directly add new items from the Overall Ranking screen.

At the bottom of the Overall Ranking screen shown in FIG. 3, additional features of this embodiment of the invention are shown. The “Export” button in the lower-left allows the Ranking in the software application to be exported into a number of formats, including text, spreadsheet, and image formats, by a number of communication methods such as email, instant message, or uploading to local, network, or internet storage. Exported Rankings may also be stored in or synchronized with online databases, or shared on Internet websites or social media platforms. Rankings may also be uploaded and aggregated into large pools of information generated by multiple users of this software interface, and these aggregated databases of user ranking information may have a multitude of commercial and research applications.

The “Template” button near the center-bottom of the Overall Ranking screen shown in FIG. 3 prompts a dialog that allows the user select two options: (1) navigate to the Template associated with the present Ranking, or (2) select a different Template to associate with the items in this Ranking. In this embodiment, a Template must be selected when the user initially creates a new Ranking, and the user is also given the option to create a new Template and associate it with the new Ranking. Selecting a different Template for an existing set of items may be useful, for example, if the user wishes to rank the same items against different sets of grouped criteria.

The “Sort” button in the lower-right corner of the Overall Ranking screen in FIG. 3 provides the user with a menu of options for sorting the list of items. These may include: alphabetical ascending or descending, overall score ascending or descending, or a return to the order in which items were initially added. In one embodiment, the user may manually adjust the order of items—for example by dragging items up or down using the touchscreen interface—and then create one or more save states for the manual sort order. The user may then retrieve the saved state(s) as one of the options available in the sort button menu.

The Category View and Item View shown in FIGS. 4 and 5 show an embodiment of the invention, built for a touchscreen interface on a mobile device, which allows the user to adjust the score of each item in each category of the Ranking using a slider control. The score is displayed numerically to the right of each slider. In this embodiment the user may also press and hold the score number to display a number keypad, allowing manual direct input of a precise score number value. This numerical input adjusts the slider, and user adjustments to the slider control similarly update the score number instantly, so the score number displayed and corresponding slider control are always synchronized.

The Category View shown in FIG. 4 is similar to the Overall Ranking screen in FIG. 3. Right and left arrows on each side of the dark bar at the top allow navigation from this Category View to other Category Views for the Ranking as well as the Overall Ranking screen. The title of the Ranking is displayed at the top center. Touching the three-bar icon in the upper-right displays the list of categories used for the Ranking, allowing the user to directly navigate to any Category View by touching its category name. In the center of the dark bar at the top, the category name is displayed, with it assigned weight next to it in parentheses. Touching an arrow to the right of each item navigates directly to the Item View for that item. Touching and holding on the item names or descriptions allows direct editing of the text displayed. The description for each item shown here is specific to that category, and may be used to describe each item's features or performance in that category. The image shown here is similarly specific to the category. A button at the bottom of the list of items allows the user to directly add new items from each Category View screen. The “Template” and “Sort” buttons on the lower-right work as described above, except that the sort button here includes an option to sort by this category's score ascending or descending.

The Category View and Item View in the embodiment shown in FIGS. 4 and 5 include “Undo” and “Redo” buttons in the lower-left corner. These assist the user in editing the Ranking, providing functionality to go back and forward through previous edits to the Ranking through presses of the undo and redo buttons. Similar buttons on the Template screen of FIG. 1 provide this functionality for the Template as well. These buttons may be shown as inactive (as shown by the “Redo” button in FIG. 4) if the user reaches the end of the history of user edits, or previous edits are otherwise unavailable.

The Item View of the embodiment shown in FIG. 5 displays a list of scores for a single item in each category. Each category is shown with the weight assigned to it in parentheses immediately after the category name. Descriptive text for the item in each category is displayed below each category name, and this may be edited directly from this screen using a touch-and-hold action. Images displayed to the right of each category name are specific to the category as well. The arrow to the right of each category navigates directly to the Category View for that category. The large photo shown at the top is the item image, which is also displayed next to that item's name in the Overall Ranking screen on FIG. 3. The item name and description also appears over this item photo, and may be edited directly from this screen. The “Sort” button in the lower-right corner works similarly to this button in the Category View screen, except that the sort button here includes an option to sort the categories in the list by this item's scores in each, ascending or descending. The right and left arrows in the dark bar at the top navigate between Item Views for each item, and the three-bar icon button on the upper-right displays a list of items so the user can directly navigate to each Item View from this screen.

In the embodiment shown in the drawings, images may be added or changed directly from any place they are displayed. For example, the user may touch a displayed image or placeholder image and hold down for a brief period to display a dialog with options for including or replacing an image. In this embodiment, shown on a touchscreen mobile device, image selection options include taking a photo using the camera on the mobile device, selecting a photo from the photo library on the device, or selecting from an internet search for images relevant to the item, category, or combination of both.

1. A method for rating items using a software interface, comprising the following steps:
(a) one or more rating criteria are presented,
(b) each rating criteria is assigned a weight,
(c) two or more items are presented,
(d) each item is assigned a score for each criteria,
(e) at least one criteria weight or item score may be adjusted by the user;
(f) the adjustment is made using a graphical user interface element;
(g) an overall rating score is provided for each item; and
(h) the overall rating score is based on the item scores in each rating criteria and the weights assigned to the rating criteria.

2. The method of claim 1, wherein the graphical user interface element is provided on a touchscreen device.

3. The method of claim 2, wherein the graphical user interface element is a slider control.

4. The method of claim 1, further comprising a numerical value representing the rating criteria weight displayed on the same screen as its corresponding graphical user interface element.

5. The method of claim 4, wherein the numerical value display is a user interface element that allows the user to adjust the criteria weight by direct numerical input.

6. The method of claim 5, wherein the numerical value display is synchronized with the graphical user interface element representing the criteria weight.

7. The method of claim 1, further comprising a numerical value representing the item score for each criteria displayed on the same screen as its corresponding graphical user interface element.

8. The method of claim 7, wherein the numerical value display is a user interface element that allows the user to adjust the item score by direct numerical input.

9. The method of claim 8, wherein the numerical value display is synchronized with the graphical user interface element representing the item score.

10. The method of claim 1, wherein a set of rating criteria and assigned weights are presented as a group.

11. The method of claim 10, wherein (i) more than one set of rating criteria and weights may be saved as a group, and (ii) the user may switch between different grouped criteria for the same set of items.

12. The method of claim 10, further comprising a graphical user interface element allowing a set of rating criteria to be locked from editing.

13. The method of claim 1, further comprising a user interface element allowing the user to add rating criteria.

14. The method of claim 1, further comprising a user interface element allowing the user to add items.

15. The method of claim 1, further comprising a user interface element allowing the user to export information presented in the rating interface for use or viewing outside of the rating interface.

16. The method of claim 1, further comprising a text description presented for one or more of the rating criteria.

17. The method of claim 1, further comprising a text description presented for one or more of the items.

18. The method of claim 1, further comprising a text description presented for one or more of the items in one or more of the rating criteria.

19. The method of claim 1, further comprising an image presented for one or more of the rating criteria.

20. The method of claim 1, further comprising an image presented for one or more of the items.

21. The method of claim 1, further comprising an image presented for one or more of the items in one or more of the rating criteria.

22. The method of claim 1, further comprising a view wherein two or more items are displayed with their overall rating scores.

23. The method of claim 1, further comprising a view wherein two or more items are displayed with their scores for a single rating criteria.

24. The method of claim 1, further comprising a view wherein a single item is displayed with its scores for two or more rating criteria.

25. The method of claim 1, further comprising at least one graphical user interface element allowing the user to navigate between at least two of the following views: (a) a view comprising two or more items displayed with their overall rating scores; (b) a view comprising two or more items displayed with their scores for a single rating criteria; (c) a view comprising a single item displayed with its scores for two or more rating criteria; and (d) a view comprising a set of rating criteria and assigned weights presented as a group.

26. The method of claim 1, wherein the basis for the overall rating score is the sum of weighted item scores for each criteria.

27. The method of claim 26, wherein weighted item scores for each criteria are calculated by multiplying the item score for each criteria by the ratio of the weight assigned to that criteria by the total weights assigned to all criteria.

28. The method of claim 27, wherein a the sum of weighted item scores for each criteria is multiplied by a constant scaling coefficient of constant value such that the overall rating scores are kept within a desired range of values.

29. The method of claim 1, further comprising a graphical user interface element allowing the user to sort items based on at least one of (a) item names, (b) overall rating scores, and (c) item scores for a single rating criterion.

30. The method of claim 1, further comprising a graphical user interface element allowing the user to sort rating criteria based on at least one of (a) rating criteria names, (b) rating criteria weights, and (c) item scores for one or more criteria.
